(19) United States
(12) Patent Application Publication
(10) Pub. No.: US 2022/0325571 A1
(43) Pub. Date: Oct. 13, 2022

(54) ELECTRONICS SYSTEM FOR CONTROLLING AN ADJUSTMENT PART BY MEANS OF AN ACCELERATION SENSOR

(71) Applicant: Brose Fahrzeugteile SE & Co. Kommanditgesellschaft, Bamberg, Bamberg (DE)

(72) Inventors: Marco SEMINETH, Bad Königshofen i. Gr. (DE); Wolfgang UEBEL, Weitramsdorf (DE); Christian HERRMANN, Großheirath (DE); Marvin HOHLFELD, Hirschaid (DE); Thomas SCHINDHELM, Neuhaus-Schierschnitz (DE); Heino SCHALYO, Altendorf (DE); Christoph HABERBERGER, Gößweinstein (DE); Alex KROMER, Stegaurach (DE); Philipp BÄUERLEIN, Heiligenstadt (DE)

(73) Assignee: Brose Fahrzeugteile SE & Co. Kommanditgesellschaft, Bamberg, Bamberg (DE)

(21) Appl. No.: 17/639,135

(22) PCT Filed: Aug. 25, 2020
(86) PCT No.: PCT/EP2020/073726

§ 371 Date: Feb. 28, 2022

(30) Foreign Application Priority Data
Aug. 28, 2019 (DE) 10 2019 212 945.5

(51) Int. Cl. E05F 15/611

(52) U.S. Cl. CPC E05F 15/611; E05Y 2201/434; E05Y 2201/408; E05Y 2800/422; E05Y 2201/216; E05Y 2400/302; E05Y 2400/36; E05Y 2400/40; E05Y 2900/531

(57) ABSTRACT

An electronics system for a vehicle including at least one acceleration sensor and an electronic control unit, which on the basis of at least one measurement signal of the acceleration sensor controls at least one drive device for the power-operated adjustment of an adjustment part of the vehicle.

### CROSS-REFERENCE TO RELATED APPLICATIONS

This application is the U.S. National Phase of PCT Application No. PCT/EP2020/073726 filed on Aug. 25, 2020, which claims priority to German Patent Application No. DE 10 2019 212 945.5, filed on Aug. 28, 2019, the disclosures of which are hereby incorporated in their entirety by reference herein.

### TECHNICAL FIELD

The present disclosure relates to an electronics system for a vehicle with at least one acceleration sensor.

### BACKGROUND

The use of acceleration sensors within a vehicle is widely known. In particular, acceleration sensors are utilized for triggering restraining devices and airbags within a vehicle. In addition, it is known to use different types of sensor devices in order to provide, for example, contactless detection of operating events for adjusting an adjustment part on a vehicle, such as a lateral or rear-side vehicle door, and/or to detect a possible case of pinching.

However, there still is a demand for electronics systems for vehicles, in particular motor vehicles, which may involve an improved comfort for the user and/or integrate a larger number of different functions.

### SUMMARY

According to one or more embodiments, there is provided an electronics system for a vehicle with at least one acceleration sensor and an electronic control unit, in which the electronic control unit controls at least one drive device for the power-operated adjustment of an adjustment part of the vehicle on the basis of at least one measurement signal of the acceleration sensor.

On the basis of at least one measurement signal of an acceleration sensor a, for example, motorized drive device is controlled, via which a power-operated adjustment of an adjustment part of the vehicle is possible. Such an adjustment part for instance can be a lateral or rear-side vehicle door, i.e. in particular a liftgate, or a trunk lid on the vehicle. In accordance with the proposed solution it is provided to take account of the measurement signal of at least one acceleration sensor for a power-operated adjustment of the adjustment part.

In one embodiment, this for example includes the fact that the electronic control unit is adapted to determine an adjustment position of the adjustment part within a permitted adjustment range on the basis of the at least one measurement signal. In systems known so far from practice, in which a power-operated adjustment is effected by an electromotive drive, an adjustment position of the adjustment part typically is detected via a sensor system at the motor, for example via at least one Hall sensor. A purely motor-side determination of an adjustment position of the adjustment part can, however, be disadvantageous when a manual adjustment of the adjustment part is also permitted. For a manual adjustment, a drive motor then for example is disconnected in order to prevent damage to the drive motor so that a drive shaft of the drive motor is not moved as well when the adjustment part, for example a vehicle door, is manually adjusted. In such a situation, it is no longer possible to infer the current adjustment position of the adjustment part via a sensor system with a motor-side Hall sensor. Rather, an additional absolute angle sensor must be provided, for example, in order to be able to infer a current opening angle in a pivotable adjustment part.

In a proposed embodiment, an acceleration sensor is used additionally or alternatively as part of a sensor system in order to infer an adjustment position of the adjustment part on the basis of a measurement signal of the acceleration sensor. Here it is possible to make use of the fact that via an acceleration sensor always the gravitational force and hence a weight force acting on the acceleration sensor is measured. In this way, the position of the acceleration sensor in space can be inferred by determining at what angle to the acceleration sensor the weight force is acting. This in turn allows to determine the adjustment position of an adjustment part including the acceleration sensor. Then, for example, an opening angle of the vehicle door can be inferred from the measurement signals of the acceleration sensor that is attached to a vehicle door.

As an example, the acceleration sensor can be adapted to generate the at least one measurement signal of the acceleration sensor during a manual adjustment of the adjustment part. The measurement signal of the acceleration sensor hence is generated to be evaluated when the adjustment part is manually adjusted. The electronic control unit then furthermore is adapted to provide at least one parameter value determined on the basis of the at least one measurement signal and representative of the determined adjustment position of the adjustment part for a future power-operated adjustment of the adjustment part. Then, for example, the situation explained above can be avoided by the fact that in a drive motor disconnected for a manual adjustment an information on the current adjustment position of the adjustment part no longer is available. Rather, even in the case of a manual adjustment the determination of the adjustment position is ensured via the acceleration sensor and hence also when a drive motor of the drive device is disconnected.

Alternatively or in addition, the electronic control unit can be adapted to generate a control signal for the drive device on the basis of the at least one measurement signal, which control signal is superimposed on a motor signal for the control of an electric drive motor of the drive device. The motor signal, which is superimposed on the control signal of the electronic control unit, for example can be a motor current signal for a drive current of the drive motor. Thus, the drive motor is actuated, for example, in dependence on the measurement signal of the at least one acceleration sensor.

In a variant based thereon, the electronic control unit then for example is adapted to generate the control signal for an active noise cancellation of an operating noise occurring in operation of the electric drive motor. The electronic control unit then for example includes a cancellation algorithm by which the control signal to be superimposed on the motor signal is generated with regard to a noise cancellation of operating noise. The electronic control unit here consequently is adapted and provided for active noise cancellation on the basis of the at least one measurement signal of the acceleration sensor. Thus, by the cancellation algorithm of the electronic control unit, for example a corresponding inverted signal can be generated, which upon superposition with the motor signal leads to a quieter operation of the electric drive motor. The at least one measurement signal of the acceleration sensor can be regarded as a measure for structureborne sound occurring in operation of the drive device and generating operating noise. When there is generated a control signal inverted with respect to the structure-borne sound (indirectly) measured in this way, which for example is superimposed on a setpoint current signal, the amplitude of the structure-borne sound can be reduced in total. The electronic control unit then consequently is adapted and provided for active counter-coupling for the purpose of noise cancellation on the basis of at least one measurement signal of the acceleration sensor.

As an example, in the embodiment explained above, the acceleration sensor can form part of a drive controller and/or be configured as an MEMS sensor for measuring the acceleration and angular velocity of an adjustment part to be adjusted. Thus, the acceleration sensor, which generates a measurement signal as a measure for structure-borne sound occurring in operation of the drive device and generating an operating noise, then for example acts as a kind of controller-side “microphone” for structure-borne sound emitted by a drive motor of the drive device and/or generated thereby.

In one embodiment, the electronic control unit is adapted to generate a control signal for the drive device on the basis of the at least one measurement signal, in response to which an at least partial decoupling of the adjustment part to be adjusted from a drive motor of the drive device is triggered, or in response to which a currently executed adjusting movement of the adjustment part is varied.

For example, the electronic control unit is adapted to generate a control signal for the actuation of an overload clutch of the drive device in order to trigger an at least partial decoupling of the adjustment part to be adjusted from a drive motor of the drive device. For example, it may be detectable by the at least one measurement signal of the at least one acceleration sensor on a vehicle door whether the vehicle door is manually accelerated (too) strongly. A possible excessive acceleration here consequently can be electronically detected by the acceleration sensor as a case of misuse, in order to then actuate an overload clutch so that a damage of the drive motor due to the adjusting force manually applied onto the vehicle door is avoided. Hence, there is provided a switchable clutch that can be switched as an overload clutch in dependence on a measurement signal of the acceleration sensor. In this case, there is no need to provide an expensive mechanical overload clutch. Rather, a case of overload can be electronically detectable by the at least one acceleration sensor, via which the clutch then can be switched correspondingly.

Moreover, in an embodiment with a switchable clutch as explained above, it can be provided that the electronic control unit is adapted to prevent a generator operation of an electric drive motor of the drive device. The electronic control unit here can be adapted to provide for decoupling within the drive device via the clutch in the case of too high a speed (i.e. a speed exceeding a stored threshold value) of the adjustment part to be adjusted. Alternatively or in addition, a highly dynamic manual action on the adjustment part to be adjusted may be detectable by the electronic control unit—and on the basis of the at least one measurement signal of the acceleration sensor. This for example includes the fact that it is detected that the adjustment part, such as a vehicle door, is quickly adjusted by a user in an adjustment direction, for example is thrown open or closed, by the user providing a short impulse to the adjustment part. In response to such an adjustment event detected by the electronic control unit—and on the basis of the at least one measurement signal of the acceleration sensor—the electronic control unit actuates the drive device to follow the adjustment direction of the short impulse with the adjustment part to be adjusted and in doing so (more) quickly adjust for example the adjustment part—adapted to the force applied by the user. After a certain time period and/or after covering a defined adjustment path, the adjustment part then is further adjusted in the adjustment direction more slowly, i.e. with a “normal” adjustment speed, in order to for example completely open or close the adjustment part.

In one embodiment, upon detection of an adjustment event with an impulse on the adjustment part to be adjusted, for example on a vehicle door, a clutch within the drive device is opened and hence the drive device is switched to operate freely. In this way, a user then only perceives the force of movement of the adjustment part switched to operated freely, which is perceived as haptically pleasant. After the user has exerted the impulse on the adjustment part and the adjustment part has been adjusted as a result of this impulse, the clutch can be actuated again and the drive motor can again be connected so that the adjustment part subsequently is (again) adjusted in a power-operated way by the motorized drive.

To ensure a movement of the adjustment part as harmonious as possible during reconnection of the drive motor in the embodiment explained above, the enabled drive motor in the freewheeling state can already be brought to a predefined rotational speed for coupling in. For this purpose, the adjustment speed of the adjustment part is measured for example via an existing sensor within the drive device and the motor speed necessary therefor is calculated, which is then adjusted. This allows the clutch to be closed without jerking.

Alternatively or in addition, one embodiment provides that a servo mode of a motorized drive device is controlled by the electronic control unit. In a corresponding servo mode, the user will be supported in a manual adjustment of an adjustment part. Here, it may be disadvantageous, however, that a corresponding drive motor has to be switched off temporarily in order to prevent damage due to overheating. This may be the case, for example, when a user has moved an adjustment part back and forth for too long. However, when the drive motor is switched to be inactive, a user must “drag along” the complete mechanism of the drive device including the drive motor in order to adjust the adjustment part. In this scenario, it can likewise be provided that the electronic control unit is adapted to actuate the clutch; but here not in dependence on a measurement signal of an acceleration sensor, but rather in dependence on another sensor, and hence e.g. in dependence on a parameter signal which for example signals the exceedance of a temperature threshold value at the drive motor.

In one embodiment, the electronic control unit is adapted to generate a control signal for the actuation of a brake of the drive device and/or the opening of a motor terminal of an electric drive motor of the drive device in order to vary the currently executed adjusting movement of the adjustment part. This variant also assumes, for example, that on the basis of the at least one measurement signal of the acceleration sensor a possible case of misuse is detectable, in which the adjustment part to be adjusted is manually adjusted (too) quickly by a user, although at the same time a motor-driven adjustment of the adjustment part is to be effected. By actuating the motorized drive in an opposite adjustment direction and/or by reducing a friction between the adjustment part to be adjusted and a body-mounted component, an overload protection can be provided. For example, in dependence on at least one measurement signal of the acceleration sensor, a reduction of a hinge friction between the vehicle door and the vehicle body is achieved by opening a motor terminal in an adjustment part in the form of a vehicle door.

When using a drive motor as part of the drive device, it can be provided in principle to actuate the drive motor via control signals having an S-shaped profile over time. S-shaped profile here may refer to a profile of the control signal over time according to a sigmoid function. For example, this includes the fact that S-shaped acceleration and/or deceleration ramps are utilized when a setpoint is specified for the speed regulation of the drive motor. A corresponding S-shaped profile does not include any discontinuities. Thus, the setpoint curve leads to an adjusting movement with merely smooth transitions. A movement of the adjustment part thus proceeds more harmoniously. Furthermore, undesired (reverberant) vibrations are avoided. In addition, higher accelerations become possible than would be possible with linearly extending ramps.

In a variant of the proposed solution the at least one measurement signal of the acceleration sensor alternatively or additionally serves to provide damage data that are representative of a possible damage to the vehicle.

One embodiment for example provides that the at least one acceleration sensor is adapted to detect knocking against a component of the vehicle, and that the at least one measurement signal is representative of detected knocking. Thus, damage events triggered for example by a person or otherwise are detected via the acceleration sensor, which are accompanied by knocking against a component, as accelerations thereby are at least locally produced on a component of the vehicle, which can be measured by the acceleration sensor. The at least one acceleration sensor thus can be adapted for example to detect knocking against an outer skin of the vehicle. As an example, at least one frequency and/or at least one amplitude of the at least one measurement signal and possibly of a plurality of consecutive measurement signals for the provision of damage data can be determined via the electronic control unit. An evaluation of the frequency and/or amplitude of the at least one measurement signal here for example allows to draw a conclusion about the kind, place and/or severity of a possible damage to the vehicle. For example, raindrops impinging on a component can easily be distinguished from a hail event or an impact against an outer skin of the vehicle.

For example, against this background the electronic control unit is adapted to distinguish at least two different types of possible damages on the basis of at least one determined frequency and/or on the basis of at least one determined amplitude. Hence, the electronic control unit can be adapted for a classification of different damages on the basis of at least one determined frequency and/or on the basis of at least one determined amplitude, e.g. with reference to a comparison with reference values stored therefor in a memory. A corresponding classification can be provided by the electronic control unit as part of the damage data. A type of a corresponding damage determined via the classification here for example is indicative of a place and/or type and/or severity of the possible damage detected via the at least one measurement signal of the acceleration sensor.

The determination of possible damages of the vehicle and the automated, electronically controlled provision of damage data therefor for example can include the fact that the damage data are provided for transmission to an application software for a mobile device. Then, for example generated damage data can be provided to a user in an app. For example, this is advantageous for vehicles from a rental car or car sharing provider. When the vehicles of the provider are equipped with an electronics system according to the embodiment explained above, the provider can automatically be informed of possible damage cases which lead to an at least local acceleration on a component of the vehicle and hence are detectable with reference to a measurement signal of an acceleration sensor. Alternatively or additionally, a user can be provided with information on damages that are occurring or have occurred on a rented vehicle.

In principle, the at least one acceleration sensor, which can be utilized for the provision of damage data, can additionally be adapted and provided to furnish a first sensor function, which is independent of a detection of a possible damage to the vehicle. The detection of a possible damage to the vehicle hence represents a second sensor function, which is fulfilled by the at least one acceleration sensor. Primarily, the acceleration sensor on the other hand can be provided for example for the determination of an adjustment position of an adjustment part to be adjusted or for the measurement of structure-borne sound on or in the adjustment part. Correspondingly, the at least one acceleration sensor can be provided for example for arrangement on or in an adjustment part for the vehicle in order to detect an adjusting movement of the adjustment part. At the same time, this acceleration sensor then can be utilized for the detection of possible damages to this adjustment part.

Typically, at least in door drives for a vehicle, acceleration sensors so far have been disposed in a controller of the drive device carrying the electronic control unit. Due to the typically constrained installation space situation in a vehicle door, it is not easily possible to place the controller for the adjustment of a vehicle door as far away as possible from a hinge axis of the vehicle door. It may be advantageous, however, to place the acceleration sensor at a distance as large as possible from a hinge axis, as thereby a comparatively large signal amplitude can be detected by the acceleration sensor during an adjustment of the vehicle door. Against this background, one embodiment provides to provide the acceleration sensor in a lock for the adjustment part, for example, in a lock that is adapted and provided for locking the adjustment part in a closed position at the vehicle. As the lock for a vehicle door for example has a comparatively large distance to an axis of rotation of the vehicle door, an acceleration sensor arranged in the lock hence is also arranged comparatively far away from an axis of rotation of the vehicle door. It can be achieved thereby that the acceleration acting on the acceleration sensor can be measured more easily, as during an adjustment of the vehicle door and this positioning of the acceleration sensor a comparatively large signal amplitude is detectable.

One variant of the proposed solution furthermore can relate to an electronics system for a vehicle with at least one sensor device for the detection of knocking against a component of the vehicle and an electronic control unit which on the basis of at least one measurement signal of the sensor device provides damage data that are representative of a possible damage to the vehicle as a result of detected knocking.

This variant of the proposed solution hence proceeds from the fact that any type of sensor device can be provided in order to evaluate knocking signals and thereby infer potential damages to the vehicle in an automated way. In conformity with the above explanations, a corresponding sensor device can of course also comprise at least one acceleration sensor.

In addition, there is proposed an electronics system with at least one sensor device for the provision of a first sensor function, in which the electronics system comprises an electronic control unit which on the basis of at least one measurement signal of the sensor device provides damage data independently of the first sensor function of the sensor device, which damage data are representative of a possible damage to the vehicle. Consequently, the electronics system here comprises a sensor device that is utilized for two different functions, namely a first sensor function and a second sensor function relating to the provision of damage data. The at least one sensor device for example can comprise an acceleration sensor.

Alternatively or additionally, the sensor device is adapted and provided to contactless detection of an operating event triggered by a person via its first sensor function, wherein in response to the detected operating event a power-operated adjustment of an adjustment part at the vehicle can be controlled. Consequently, a corresponding sensor function for example can be adapted and provided to contactless detection of a gesture executed by a person via its first sensor function, at least as part of an operating event for adjusting an adjustment part at the vehicle. Then, however, at least one measurement signal of the sensor device is additionally utilized for a second sensor function in order to detect possible damage events and therefor provide corresponding damage data.

The subject-matter of the proposed solution furthermore is a vehicle comprising an embodiment of a proposed electronics system.

As an example, in such a vehicle a plurality of different electronic control units can be provided for the control of different functions at the vehicle. It may be recommendable here to link the individual electronic control units and the individual controllers each integrating the electronic control units, respectively, with each other. As an example, a logical coupling of individual or all controllers can be provided, for example in order to implement a synchronization of different functions to be controlled thereby. For example, a door controller for a window lifter and a door controller for the adjustment of a vehicle door can be linked with each other. Then, this for example allows a synchronized adjustment of a window of a vehicle door and the vehicle door itself, optionally also for several doors at the same time. Then, for example an adaptation of the respective motor actuation is provided, in order to ensure in one embodiment that the respective end positions of all doors and windows are reached at the same time. In this way, a relief of the on-board network of the vehicle possibly can be achieved.

Alternatively or additionally it can be provided that different functions are sequentially actuated by the networked controllers in a targeted way. Then, it can be ensured for example that first a vehicle door is closed and subsequently a window of this vehicle door is closed.

The proposed solution furthermore also includes the use of an acceleration sensor for controlling a power-operated adjustment of an adjustment part at a vehicle. Alternatively or additionally, the use of an acceleration sensor can be provided to furnish damage data that are representative of a possible damage to the vehicle.

As explained already, there can furthermore be comprised the use of a sensor device that is adapted and provided to furnish a first sensor function at a vehicle, in order to additionally provide damage data via the sensor device, which are representative of a possible damage to the vehicle, namely independently of the first sensor function of the sensor device.

In addition, there can be provided a method for the electronic provision of damage data, in which the damage data are provided by at least one sensor device, in that knocking against a component of the vehicle is detected by at least one sensor device.

The attached Figures by way of example illustrate possible embodiments of the proposed solution.

### BRIEF DESCRIPTION OF THE DRAWINGS

In the drawings:

FIG. 1 sectionally shows a vehicle with an embodiment of a proposed electronics system on a lateral vehicle door of the vehicle;

FIG. 2 sectionally shows a vehicle with an electronics system according to the proposed solution on a liftgate of the vehicle;

FIG. 3 shows a schematic representation of a control of a drive motor of a drive device, for example for the adjustment of an adjustment part corresponding to the embodiments of FIGS. 1 and 2, on the basis of a measurement signal of an acceleration sensor for the active noise cancellation for an operating noise of the drive motor;

FIG. 4 shows an exemplary profile of a sigmoid function for a setpoint profile in the actuation of the drive motor.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Sensor devices known from the prior art are known for the contactless detection of gestures for the adjustment of adjustment parts, which comprise a capacitive sensor, an ultrasonic sensor, a radar sensor and/or an optical sensor, such as a TOF camera. In particular via such sensor systems, it is also possible in addition to draw conclusions about possible damage events that have occurred at the vehicle. This in particular includes the possibility to use a corresponding sensor system to record when an adjustment part has been adjusted by gesture control, when previously or subsequently a possible damage event has been/is detected.

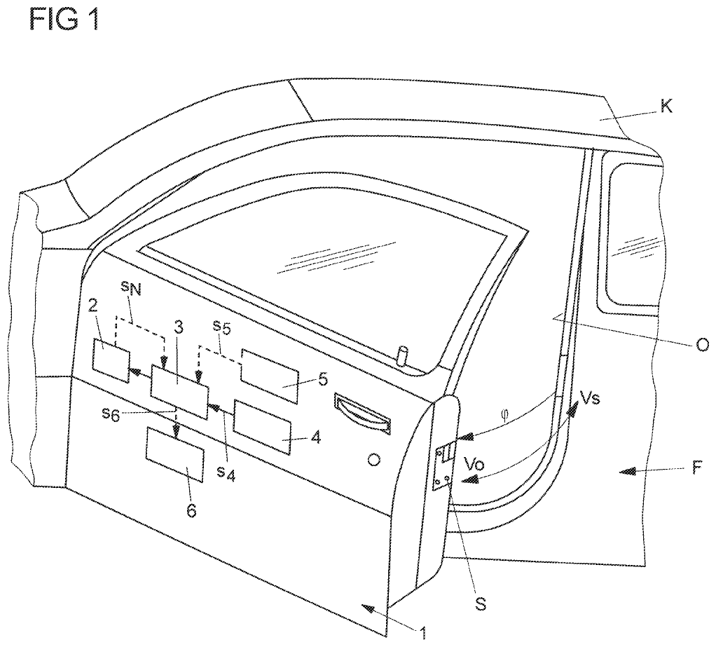

FIG. 1 sectionally shows a vehicle F in which a lateral body opening O in a body K of the vehicle F can be closed by a pivotally mounted vehicle door 1 as an adjustment part. The vehicle door 1 is pivotable about a pivot axis along two mutually opposite adjustment directions Vo and Vs, in order to open or to close the vehicle door 1. Proceeding from a closed position at the body K, the vehicle door 1 can be adjusted along the adjustment direction Vo in the direction of a maximally open end position. An opening angle φ defines the degree of pivoting of the vehicle door 1 from the completely closed end position.

In the present case, the vehicle door 1 is adjustable in a power-operated way by a drive device 2. The drive device 2 for instance comprises a (for example electric) drive motor as well as a transmission and/or a clutch. An adjusting force applied by the drive device 2 for positioning the vehicle door 1 here for example is controlled via an electronic control unit 3. Furthermore, an acceleration sensor 4 is arranged within the vehicle door 1, which is utilized for example to determine whether the vehicle door 1 currently is adjusted. In principle, the acceleration sensor 4 can be provided for example on a lock S of the vehicle door 1. The acceleration sensor 4 thereby is maximally spaced apart from a pivot axis of the vehicle door 1, which in turn leads to a comparatively large and hence easily detectable signal amplitude during an acceleration of the vehicle door 1.

In the illustrated embodiment, the acceleration sensor 4 alternatively or additionally is utilized to control the power-operated adjustment of the vehicle door 1 and/or to provide damage data which are representative of a possible damage to the vehicle F. The acceleration sensor 4 therefor transmits measurement signals S₄ to the electronic control unit 3. On the basis of these measurement signals S₄, the electronic control unit 3 for example can generate a parameter value representative of the current adjustment position of the vehicle door 1 when the vehicle door 1 is manually adjusted. The generated parameter value then for example is available for a future power-operated adjustment of the vehicle door 1, so that in the event of a subsequent power-operated adjustment by the drive device 2 the current adjustment position is known, even if a drive motor of the drive device 2 has not been active.

Alternatively or additionally, a partial decoupling of the vehicle door 1 from a drive motor of the drive device 2 can be triggered in response to a measurement signal S₄ of the acceleration sensor 4. Alternatively, a currently executed adjusting movement of the vehicle door 1 can be varied, for example by actuating a brake or by reversing an adjusting movement.

In addition, a possible vibration on an outer skin of the vehicle door 1 possibly may be detectable via the at least one acceleration sensor 4 and a measurement signal S₄ generated thereby, which vibration is due to knocking against the outer skin or another vibration generation. Thus, the occurrence of a possible damage event at the outer skin of the vehicle door 1 can be inferred from a corresponding measurement signal S₄. The electronic control unit 3 then is adapted and provided to generate corresponding damage data and store the same for further processing. The damage data therefor can be transmitted to a memory device 6 coupled with the electronic control unit 3. Alternatively or additionally, the device 6 can also be an output device which then sends the damage data for example to a server and/or a mobile device of a user. On the basis of a transmission signal S₆ from the electronic control unit 3 to the device 6, the corresponding damage data consequently can be stored for example in readable form only or can be transmitted further.

In one embodiment, a gesture sensor 5 additionally is integrated in the vehicle door 1. This gesture sensor 5 for example comprises a capacitive sensor, an ultrasonic sensor, a radar sensor and/or an optical sensor in order to detect a gesture executed by a person in an environment of the vehicle door 1 as a possible operating event for opening or closing the vehicle door 1. To trigger an adjustment of the vehicle door 1 in response to a correspondingly detected gesture-based operating event, a measurement signal ss of the gesture sensor 5 is transmitted to the electronic control unit 3, which in dependence thereon can actuate the drive device 2 for adjusting the vehicle door 1. In one embodiment, a measurement signal S₅ received from the gesture sensor 5 furthermore can likewise be utilized for generating damage data relating to possibly occurred damage events.

Furthermore, in one embodiment, a measurement signal S_{N} of an acceleration sensor integrated in the drive device 2 is received and evaluated by the electronic control unit 3. A drive-side acceleration sensor for generating the measurement signal S_{N} is provided for example in the form of an MEMS sensor and (primarily) serves the determination of an acceleration of the vehicle door 1. On the basis of the proposed solution, this measurement signal S_{N} of the drive-side acceleration sensor—alternatively or in addition to the measurement signal S₄ of the other acceleration sensor 4—can be utilized to superimpose a motor current signal for the control of an electric drive motor of the drive device 2 with a control signal generated by the electronic control unit 3, in order to achieve an active noise cancellation of operating noise occurring in operation of the electric drive motor. Thus, a corresponding acceleration sensor can be utilized as a “microphone” for a structure-borne sound emitted and/or generated by the drive motor. Thus, a measurement signal of the corresponding acceleration sensor serves as a measure for the structure-borne sound, all the more so as an inverted control signal can be formed, which during superposition with an actual setpoint current signal for the control of the drive motor serves to reduce the amplitude of the structure-borne sound in total.

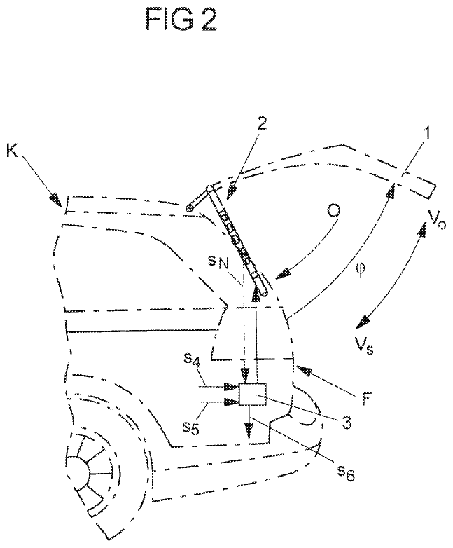

As is illustrated by way of example with reference to the embodiment of FIG. 2, the proposed solution can also be utilized for example in connection with a liftgate 1 as an adjustment part on the vehicle F.

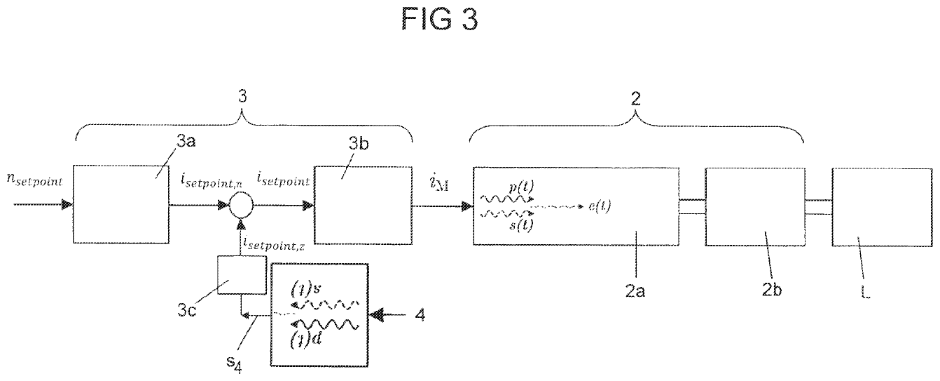

Furthermore, FIG. 3 by way of example illustrates the procedure outline above for an active noise cancellation. The measurement signal S₄ and/or S_{N} generated by the acceleration sensor 4 and/or a drive-side acceleration sensor here is supplied to an evaluation logic 3c of the electronic control unit 3 configured with a cancellation algorithm, which determines a control signal i_{setpoint,z} on the basis of the measurement signal S₄ and/or S_{N} of the acceleration sensor 4. This control signal i_{setpoint,z} is superimposed on a motor control signal i_{setpoint,n}, which is generated by a speed regulator 3a of the electronic control unit 3 on the basis of a setpoint speed nₛₑₜₚₒᵢₙₜ. The superposition results in a setpoint signal iₛₑₜₚₒᵢₙₜ which is supplied to a current regulator 3b of the electronic control unit 3. The current regulator 3b in turn generates a motor current signal i_{M} for an electric drive motor 2a of the drive device 2. A drive moment generated by this drive motor 2a is supplied to a transmission 2b and then leads to the adjusting force for the adjustment of the respective adjustment part 1, which in FIG. 3 is represented by a load L.

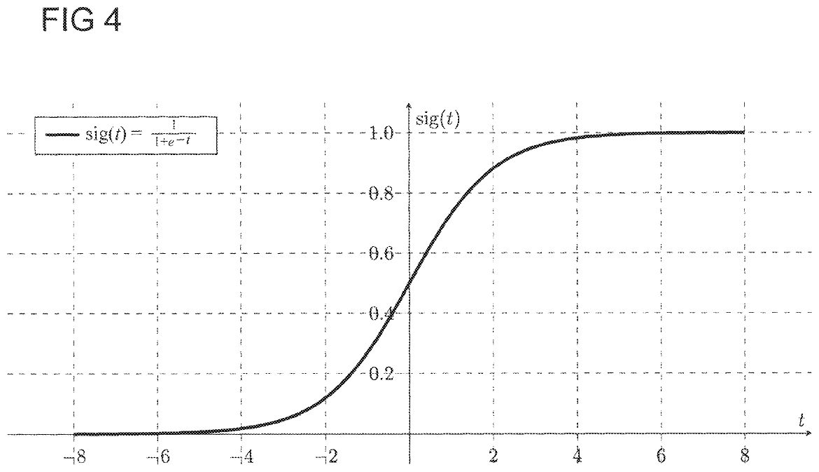

FIG. 4 by way of example illustrates a sigmoid function and hence an S-shaped profile for a motor current signal to the electric drive motor 2a of the drive device 2. This S-shaped profile with smooth transitions in principle can be utilized to operate the drive motor 2a comparatively jerk-free and hence more quietly.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### LIST OF REFERENCE NUMERALS

1 vehicle door/liftgate (adjustment part)

2 drive device

2a transmission

2b motor

3 electronic control unit

3a speed regulator

3b current regulator

3c evaluation logic

4 acceleration sensor

5 gesture sensor

6 output device/memory device

F vehicle

K body

L load

O body opening

S lock

S₄, S₅, S₆ signal

S_{N} signal

V_{O}, V_{S} adjustment direction

φopening angle

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. An electronics system for use in a vehicle, the electronics system comprising:
an acceleration sensor; and
an electronic control unit configured to control a drive device based a measurement signal of the acceleration sensor, wherein the drive device is configured to provide power-operated adjustment of an adjustment part of the vehicle.

2. The electronics system of claim 1, wherein the electronic control unit is configured to determine an adjustment position of the adjustment part within a permitted adjustment range based on the measurement signal.

3. The electronics system of claim 2, wherein the acceleration sensor is configured to generate the measurement signal during a manual adjustment of the adjustment part, and the electronic control unit is configured to provide at a parameter value based on the measurement signal, and wherein the parameter value is representative of the determined adjustment position of the adjustment part for a future power-operated adjustment of the adjustment part.

4. The electronics system of claim 1, wherein the electronic control unit is configured to generate and provide a control signal to the drive device based on the measurement signal, wherein the control signal is superimposed on a motor signal to control an electric drive motor of the drive device.

5. The electronics system of claim 4, wherein the electronic control unit is configured to generate the control signal to provide active noise cancellation of an operating noise occurring during operation of the electric drive motor.

6. The electronics system of claim 1, wherein the electronic control unit is configured to generate and provide a control signal to the drive device, wherein the control signal is based on the measurement signal, wherein the drive device is configured to, responsive to receiving the control signal,
at least partially decouple the adjustment part from a drive motor of the drive device is triggered, or
vary an adjusting movement of the adjustment part is as the adjustment part is adjusted.

7. The electronics system of claim 6, wherein the drive device is configured to, responsive to receiving the control signal, actuate an overload clutch of the drive device in order to at least partially decouple the adjustment part from the drive motor of the drive device.

8. The electronics system of claim 7, wherein drive device is configured to, responsive to receiving the control signal,
actuate a brake of the drive device, and/or
open a motor terminal of an electric drive motor of the drive device to vary the adjusting movement of the adjustment part as the adjustment part is adjusted.

9. The electronics system of claim 1, wherein the acceleration sensor is configured to be arranged on the adjustment part or in adjustment part to detect an adjusting movement of the adjustment part.

10. The electronics system of claim 1, wherein the acceleration sensor is provided on a lock or in a lock.

11. (canceled)

12. (canceled)

13. A method of providing power-operated adjustment of an adjustment part of a vehicle, the method comprising:
receiving, by an electronic control unit, a measurement signal from an acceleration sensor; and
controlling, by the electronic control unit, a drive device to provide power-operated adjustment of the adjustment part based on the measurement signal.

14. The method of claim 13, further comprising:
determining, by the electronic control unit, an adjustment position of the adjustment part within a predetermined adjustment range based on the measurement signal.

15. The method of claim 13, further comprising:
generating, by the acceleration sensor, the measurement signal in response to a manual adjustment of the adjustment part; and
generating, by the electronic control unit, a parameter value indicative of a position of the adjustment part during or after the manual adjustment of the adjustment part.

16. The method of claim 13, further comprising:
generating, by the electronic control unit, a control signal;
superimposing the control signal on a motor signal of a motor of the drive device; and
providing the control signal to the drive device control the drive device.

17. The method of claim 16, further comprising:
at least partially decoupling the adjustment part from the motor of the drive device.

18. The method of claim 17, wherein the at least partially decoupling step includes actuating an overload clutch of the drive device.

19. The method of claim 13, further comprising:
generating, by the electronic control unit, a control signal;
operating the drive device based on the control signal to generate active noise cancellation of a noise generated by an electric drive motor the drive device.

20. A vehicle comprising:
an acceleration sensor; and
an electronic control unit configured to control a drive device based a measurement signal of the acceleration sensor, wherein the drive device is configured to provide power-operated adjustment of an adjustment part of the vehicle.
